(19) United States
(12) Patent Application Publication
(10) Pub. No.: US 2011/0272508 A1
(43) Pub. Date: Nov. 10, 2011

(54) Process for Separating Limonite and Saprolite

(76) Inventors: Damien Krebs, Kensington (AU); Graham Andrew Reynolds, Kotara South (AU); Harald Theowald Muller, Eleebana (AU)

(21) Appl. No.: 13/106,549

(22) Filed: May 12, 2011

(30) Foreign Application Priority Data
Nov. 28, 2008 (AU) 2008906178
Nov. 26, 2009 (AU) PCT/AU2009/001544

(51) Int. Cl. B02C 19/00; B03B 5/00

(52) U.S. Cl. 241/30; 209/155

(57) ABSTRACT

A method for separating nickel containing lateritic ore into limonite and saprolite fractions that includes subjecting a lateritic ore slurry to a size separation procedure to separate the limonite and saprolite fractions on a selected threshold particle size basis and determining a threshold particle size based on an analysis of particle size fractions by determining a particle size where substantially all of the particles having a characteristic compositional range of at least one indicator element for limonite are smaller than the determined threshold particle size, and/or substantially all of the particles having a compositional range of at least one indicator element for saprolite are larger than a determined threshold particle size.

This application claims priority to and is a continuation of PCT Application Serial No. PCT/AU2009/001544 filed Nov. 26, 2009 published in English on Jun. 3, 2010 as PCT WO 2010/060144; and to Australian Application No. 2008906178 filed Nov. 28, 2008, the entire contents of each are incorporated herein by reference.

### FIELD OF THE INVENTION

The present invention relates to a process for separating limonite and saprolite lithologies of a lateritic ore. The invention particularly relates to a process for separating limonite and saprolite lithologies based on particle size.

### BACKGROUND TO THE INVENTION

Lateritic nickel and cobalt ore deposits are renowned for the variability in mineralisation that occurs through the depth of the ore body. However a typical lateritic nickel deposit can be divided into two main zones which occur at increasing depths from the surface and treatment processes are varied to suit the nature of the mineralisation.

A laterite ore body generally consists of a limonite upper layer and a saprolite lower layer. The term “limonite” refers to the high iron (at least 25 wt. % Fe) and low magnesium (0.5 to 6 wt. % Mg) fraction which contains goethite, FeOOH, with nickel grades from 0.8 to 1.5%. Similarly, the term “saprolite” denotes the low iron (5-20 wt % Fe) and high magnesium (at least 8 wt. % Mg) fraction containing various magnesium silicates and nickel grades in the range 1.3 to 2.2%.

The higher nickel content saprolites tend to be commercially treated by a pyrometallurgical process involving roasting and electrical smelting techniques to produce ferro nickel. The power requirements and high iron to nickel ore ratio for the lower nickel content limonite and limonite/saprolite blends make this processing route too expensive, and these ores are normally commercially treated by a hydrometallurgical process such as the High Pressure Acid Leach (HPAL) process or combination of pyrometallurgical and hydrometallurgical processes such as the Caron reduction roast-ammonium carbonate leach process.

Other hydrometallurgical acid leaching techniques have been developed to exploit nickeliferous oxidic ore in the past decade apart from conventional high pressure acid leach (HPAL). For example enhanced pressure acid leach (EPAL) is described in U.S. Pat. No. 6,379,636 and WO 2006/084335 in the name of BHP Billiton. Atmospheric agitation leaching with iron precipitation as jarosite is described in U.S. Pat. No. 6,261,527 also in the name of BHP Billiton, and atmospheric agitation leaching with iron precipitation as goethite is described in Australian application 2003209829 in the name of QNI Technology. A process for direct atmospheric leaching of the saprolite component is described in U.S. Pat. No. 6,379,637 in the name of Curlook.

Separation of the ore fractions from the limonite and saprolite zones is therefore typically desirable in order to apply the appropriate respective recovery techniques thereto.

The exploitation of many of the marginal nickel content ore bodies is made difficult because it is typically not possible to beneficiate a laterite ore body other than by selective mining techniques. However, effective selective mining of laterites is not always possible where the differentiation between the limonite and saprolite lithologies is inconsistent or not clearly defined.

It would accordingly be desirable to provide a process for such ore bodies in which the limonite and saprolite fractions of run of mine laterite ore may be separated without requiring or depending upon selective mining of the ore. Such a process would allow mining of the full ore body, with subsequent separation of the fractions, thereby reducing the cost and complexity of mining and separation, improving the separation efficiency, and reducing downstream processing costs.

The above discussion of the background of the invention is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

Nickel containing laterite ore deposits generally consist of two broad mineral ore fractions, namely the upper limonite ore fraction, and the lower saprolite (or silicate type) ore fraction. The limonite and saprolite ore fractions can generally be distinguished by their lithologies; the limonite fraction being highly enriched in iron due to very strong leaching of magnesium and silica, while the saprolite fraction is lower in iron, but higher in magnesium, amongst other distinguishing lithological characteristics. The limonite fraction is generally finer than the saprolite, predominantly due to its high goethite content, while the saprolite consists of coarser silicates.

In order to separate the limonite from the saprolite, some suitable laterite ore deposits may be selectively mined to first remove the upper limonite fraction and then separately mining the lower saprolite ore. Alternatively, where the separation of the limonite and saprolite is poorly defined, the whole ore may be mined and either processed as a mix inefficiently, or, depending on the physical nature of the ore, subjected to size separation where all the fine limonite rich material is separated from the coarser saprolite rich material through various screening techniques.

Both selective mining and size separation by screening are relatively effective, but fairly large contamination of the ore fractions may still occur. The present invention aims to provide an alternative improved means for processing the laterite ore by classifying the ore based on accepted mineral lithologies of the limonite and saprolite fractions to assist in selectively separating the ore by appropriate screening.

The selective separation of the ore is achieved by determining an appropriate threshold particle size, which is a term used herein to define a particle size where substantially all the particles that have the characteristic compositional range of certain elements that characterise limonite ore are smaller than the determined threshold particle size, and/or substantially all particles that have the characteristic compositional range of certain elements that characterise saprolite ore are larger than this threshold particle size.

The term characteristic compositional range is a term used herein to indicate a compositional range of a particular element or elements, herein referred to as indicator elements, that are known to characterise the lithology of the respective limonite and saprolite ore fractions.

According to the present invention, there is provided a method for separating nickel containing lateritic ore into its limonite and saprolite fractions, the method including the steps of:
(a) providing said nickel containing lateritic ore in particulate form;
(b) forming a slurry of said particulate ore;
(c) subjecting the ore slurry to a size separation procedure to separate the limonite and saprolite fractions on a selected threshold particle size basis wherein the threshold particle size is determined by
   i) providing a representative sample of said lateritic ore containing said limonite and saprolite fractions, each having a characteristic compositional range of at least one and preferably two or more indicator elements,
   ii) subjecting said sample to a particle size classification procedure in which the sample is separated into a number of particle size fractions;
   iii) analysing a selected number of the particle size fractions to determine the amount of said at least one indicator element in each particle size fraction analysed; and
   iv) determining said threshold particle size based on the analysis of the particle size fractions by determining a particle size where substantially all the particles having the characteristic compositional range of the at least one indicator element for limonite are smaller than the determined threshold particle size, and/or substantially all the particles having the characteristic compositional range of the at least one indicator element for saprolite are larger than the determined threshold particle size.

The particulate ore will typically be ore which has passed through a primary crushing stage to eliminate large rocks and provide the ore in a suitable size for slurrying.

The ore slurry is formed by mixing the ore with one or more of fresh water, seawater, underground brine or hypersaline water, depending on availability and processing requirements.

It is a particularly preferred feature of the process of the invention that the ore slurry is subjected to wet scrubbing prior to the size classification procedure. Wet scrubbing comprises agitating a slurry of the ore particles resulting in the “scrubbing” of finer particles from the surfaces of coarser particles, and consequent enhanced separation of the particle sizes.

The size separation procedure utilises a wet size separation technique, such as wet screening, wet cyclone classification, or a combination thereof. If wet screening is not sufficient to separate the two fractions clearly, such as where the average particle size is quite small, wet cyclone classification may need to be employed either by itself or in combination with wet screening.

Where the oversize fraction is particularly coarse, it may need to be subjected to a secondary crushing step, possibly together with a subsequent grinding step before processing to recover the metal values.

The limonite and saprolite fractions are typically the undersize and oversize fractions, respectively, relative to a threshold particle size. The respective mineralogies of the limonite and saprolite fractions largely dictate their physical characteristics and typically the limonite fraction has a relatively fine particle size range and the saprolite fraction has a relatively coarse particle size range. Without wishing to be limited to a particular mechanism, this difference in particle size is believed to be largely due to the higher concentration of relatively harder silicates in saprolite.

The threshold particle size is preferably determined by subjecting a representative sample of the ore to a wet screening and/or wet cyclone classification process in which the sample is classified into a number of size fractions. Each size fraction is then analysed to determine the amount of at least one indicator element or elements in each. Preferably, the indicator elements are iron and/or magnesium as the amount of these elements may readily be used to characterise limonite and saprolite ores by the compositional range of iron and/or magnesium in each size fraction.

It is preferred to analyse a selected number of differing size fractions so as to develop a chart, graph, table or any other form of tabulation based on the compositional range of the indicator element or elements in each size fraction. By this means, the threshold particle size can be determined by analysing the tabulation to see at what approximate particle size below which substantially all the particles having the characteristic compositional range of the indicator elements or elements for limonite fall. A similar analysis may be made for the saprolite ore fraction. A determination may then be made that ore particles that are smaller than the determined threshold particle size are limonite while the particles that are larger than the threshold particle size are saprolite. The lateritic ore can then be separated using the determined threshold particle size as the particle size at which the limonite and saprolite ore fractions are separated preferably by scrubbing followed by wet screening and/or wet cyclone classification techniques.

Typically the limonite fraction contains the indicator elements iron and magnesium in the approximate respective compositional ranges of at least 25 wt. % Fe and 0.5 to 6 wt. % Mg. The saprolite fraction typically contains the indicator elements iron and magnesium in the respective compositional ranges of 5-20 wt % Fe and at least 8 wt. % Mg. However, there can be significant variations in these compositional ranges in nature and each ore body needs to be assessed on an individual basis.

Where iron and/or magnesium are used as the indicator elements, an analysis would be undertaken to determine the amount of iron and/or magnesium in the respective size fractions, and if that fraction has greater or less than the characteristic compositional ranges of iron and/or magnesium, that ore fraction may be classified as either limonite or saprolite. It then becomes possible to determine the threshold particle size for each of the limonite and saprolite fraction based on the size of the ore having the characteristic compositional range for the limonite and/or saprolite fractions.

The analysis to determine the compositional ranges of iron and/or magnesium preferably comprises a chemical assay which typically includes an analysis of a number of different elements in addition to iron and magnesium, such as nickel, cobalt, aluminium, silicon, copper, manganese and zinc. While iron and/or magnesium are likely to be the indicator elements used in the process of the invention, it is to be understood that other elements which tend to preferentially concentrate in one fraction or another and affect processing costs may also be used in selecting the size cut value, for example silicon or aluminium.

When the appropriate threshold particle size for a particular ore deposit has been determined, the remainder of the lateritic particulate ore may be separated into limonite and saprolite fractions on the basis of the threshold particle size, for example by wet screening or wet cyclone classification described herein.

The appropriate threshold particle size used to determine the limonite ore particles from the saprolite ore particles will vary from ore deposit to ore deposit. It has been found in various laterite ore deposits that limonite type ore may be relatively coarse, for example with particle size of up to 8 mm. In such deposits, the limonitic ore fraction is determined by ore having a particle size of less than for example 8 mm, as ore particles up to this size have the characteristic compositional range for limonite. In this case, the saprolitic ore fraction is determined as ore having a particle size greater than 8 mm as ore particles above this size will, in general, have the characteristic compositional range of saprolite. The threshold particle size in this case is 8 mm.

In other deposits the undersize limonitic type ore may be determined as much finer ore having a particle size less than for example, 38 μm with the saprolitic ore fraction having a particle size greater than 38 μm. In this case, the threshold particle size is 38 μm.

The appropriate threshold particle size should be determined for each ore deposit leading to an ore separation process where the limonite and saprolite ore are classified once the threshold particle size has been determined, as the threshold particle size is most likely to vary from deposit to deposit.

It is an advantage of the present invention that it can be used to separate the limonite and saprolite fractions from nickel containing lateritic ore, particularly where poor definition of the limonite and saprolite layers in the ore body preclude selective mining of the two. The process may advantageously be used to process bulk mined run-of-mine ore. Accordingly, if the process of the invention is adopted, it is not necessary to selectively mine the ore or adopt other screening separation processes which are based on poorly defined size separation techniques.

### BRIEF DESCRIPTION OF THE DRAWINGS

The invention will be better understood by reference to the Examples and accompanying drawings, in which:

FIG. 1 is a flow sheet showing the separation of limonite and saprolite fractions of a laterite ore from the Sangaji deposit, Indonesia

FIG. 2 is a graph illustrating the concentration of magnesium and iron in the particle size fractions separated from the Sangaji ore.

FIG. 3 is a graph illustrating the concentration of magnesium and iron in the particle size fractions separated from a laterite ore from the CMSA deposit, Columbia.

### DETAILED DESCRIPTION OF THE PREFERRED EMBODIMENTS

### Example 1

### Sangaji Deposit, Indonesia

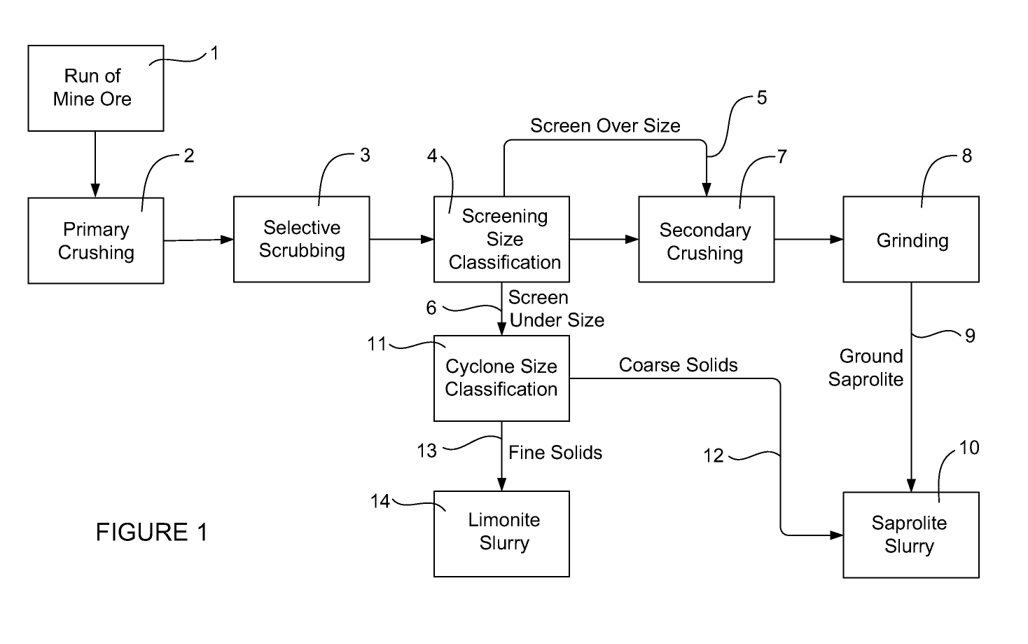

FIG. 1 is a flow sheet showing an embodiment of the invention for separating limonite and saprolite fractions of a laterite ore from the Sangaji deposit in Indonesia.

Run-of-mine lateritic ore (1) is subjected to a primary crushing step (2) to produce particulate ore which is then formed into a slurry and subjected to a selective scrubbing step (3). During the selective scrubbing step (3), the slurry is agitated, thereby causing the “scrubbing” of the finer particles from the surfaces of coarser particles. The scrubbed slurry proceeds to a size classification stage (4) comprising a wet screening process. The size classification stage (4) results in the separation of oversize (5) and undersize (6) fractions, respectively, relative to a predetermined threshold particle size.

The oversize fraction (5) is largely saprolitic in composition and, if necessary, undergoes a secondary crushing step (7) followed by a grinding step (8). The ground saprolite (9) is then formed into a slurry (10) which can subsequently be treated as required for recovery of nickel and cobalt.

Depending on the magnitude of the threshold particle size, the undersize fraction (6) may need to undergo additional size classification. If so, the undersize fraction (6) is subjected to a wet cyclone classification step (11). The coarse fraction (12), being largely saprolitic in composition, is fed to the saprolite slurry (10). The fine fraction (13), being largely limonitic in composition, is formed into a limonite slurry (14), which may then be treated as desired for nickel and cobalt recovery.

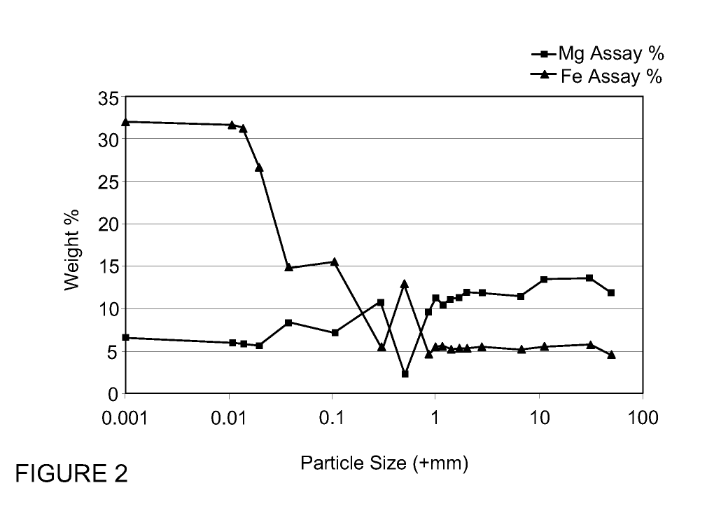

FIG. 2 is a plot of composition versus particle size fraction for the Sangaji ore after particle size classification. In FIG. 2, the weight percentage of the indicator elements magnesium (squares) and iron (triangles) in each fraction are plotted against the upper limit of each particle size range (+mm). As can be seen in FIG. 2, at particle sizes of less than approximately 38 μm the respective weight percentages of iron and magnesium in the fractions fall within the typical ranges for limonite (ie. at least about 25 wt % Fe and from approximately 0.5 to 6 wt % Mg). Accordingly, the threshold particle size for the Sangaji ore is determined to be 38 μm. Having determined this threshold particle size, it would then be a matter of separating the remainder of the particulate run-of-mine ore on the basis of the threshold particle size: ie. ore fractions having a particle size below this value would be expected to be largely limonite and those being a particle size above this value would be expected to be largely saprolite.

### Example 2

### CMSA Deposit, Columbia

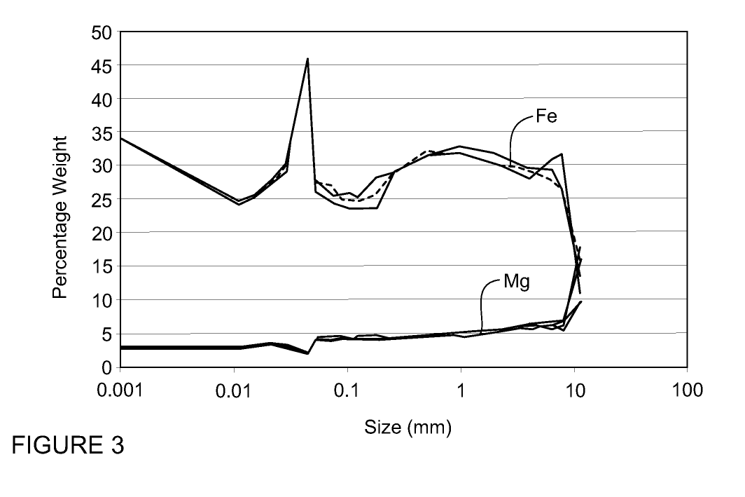

FIG. 3 is a plot of composition versus particle size for crushed laterite ore from the CMSA Deposit in Columbia, after it had been subjected to particle size classification

A representative, approximately 2 kg, sample, of the crushed ore was slurried and subjected to wet scrubbing. The scrubbed slurry was then washed over the following screen sizes:
11.2 mm, 8 mm, 6.3 mm, 4 mm, 2 mm, 1 mm, 500 μm, 250 μm, 180 μm, 125 μm, 106 μm, 90 μm, 75 μm and 53 μm.

The 53 μm fraction was further separated with a wet cyclone “cyclosizer”. Assuming an ore specific gravity of 2.6 at 25° C. the cyclosizer cut the fine material at 45 μm, 29 μm, 21 μm, 15 m and 11 μm.

A total of four subsamples was analysed for each particle size fraction. FIG. 3 plots the weight percent of the indicator elements iron (Fe) and magnesium (Mg) determined for each subsample, against the particle size fraction. As can be seen, below about 8 mm, the composition of the ore fractions approximates that of limonite (ie. at least about 25 wt % Fe and from 0.5 to 6 wt % Mg). Accordingly, the threshold particle size for the CMSA ore was determined to be 8 mm, and the remainder of the ore may be separated on the basis of this threshold particle size.

The above two examples demonstrate that the threshold particle size varies from one ore deposit to another. While the Sangaji threshold particle size was quite fine (38 μm), the CMSA threshold particle size was quite coarse (8 mm). It is accordingly necessary to individually determine the threshold particle size for each particular ore deposit, which may vary according to the individual characteristics of the ore deposit.

The invention described herein is susceptible to variations, modifications and/or additions other than those specifically described and it is to be understood that the invention includes all such variations, modifications and/or additions which fall within the spirit and scope of the above description.

Further patent applications may be filed in Australia or overseas on the basis of, or claiming priority from, the present application. It is to be understood that the following provisional claims are provided by use of example only and are not in tended to limit the scope of what may be claimed in any such future applications. Features may be added to or omitted from the provisional claims at a later date so is to further define or re-define the invention or inventions.

1. A method for separating nickel containing lateritic ore into limonite and saprolite fractions, the method including the steps of:
(a) providing said lateritic ore in particulate form;
(b) forming a slurry of said particulate ore;
(c) subjecting the ore slurry to a size separation procedure to separate the limonite and saprolite fractions on a selected threshold particle size basis wherein the threshold particle size is determined by
i) providing a representative sample of said lateritic ore containing said limonite and saprolite fractions, each having a characteristic compositional range of at least one indicator element,
ii) subjecting said sample to a particle size classification procedure in which the sample is separated into a number of particle size fractions;
iii) analysing a selected number of the particle size fractions to determine the amount of said at least one indicator element in each fraction analysed; and
iv) determining said threshold particle size based on the analysis of the particle size fractions by determining a particle size where substantially all of the particles having the characteristic compositional range of the at least one indicator element for limonite are smaller than the determined threshold particle size, and/or substantially all of the particles having the compositional range of the at least one indicator element for saprolite are larger than the determined threshold particle size.

2. A method according to claim 1, wherein said size classification procedure is a wet size separation technique.

3. A method according to claim 2 wherein the wet size separation technique is wet screening, wet cyclone classification, or a combination thereof.

4. A method according to claim 1, wherein said ore slurry is subjected to wet scrubbing prior to said size classification procedure.

5. A method according to claim 1, wherein said limonite and saprolite fractions are the undersize and oversize fractions, respectively, relative to the threshold particle size.

6. A method according to claim 1, wherein said at least one indicator element in the analysis is one or both of iron and magnesium.

7. A method according to claim 1 wherein a chart, graph, table or other form of tabulation is developed based on the compositional range of the at least one indicator element in each sample analysed, and the threshold particle size is determined by analysing the tabulations such that those particles having the characteristic compositional range of the at least one indicator element for limonite are smaller than the threshold particle size and those particles having the characteristic compositional range of the at least one indicator element for saprolite are larger than the threshold particle size.

8. A method according to claim 1 wherein the characteristic compositional range for the limonite fraction is greater than 25 wt % iron and/or from 0.5 to 6 wt % magnesium, and the characteristic compositional range for the saprolitic fraction is from 5 to 20 wt % of iron and/or greater than 8 wt % magnesium.

9. A method according to claim 1 wherein the threshold particle size is 8 mm with substantially all ore particles having the characteristic compositional range of the at least one indicator element of limonite being of a size of 8 mm or less.

10. A method according to claim 1 wherein the threshold particle size is 38 μm with substantially all ore particles having the characteristic compositional range of the at least one indicator element of limonite being of a size of 38 μm or less.

11. A method according to claim 1 wherein said nickel containing lateritic ore also contains cobalt ore.

12. A method according to claim 1 wherein said nickel containing lateritic ore is bulk mined run-of-mine ore.

13. A process according to claim 1, wherein said particulate ore is provided by primary crushing of the nickel containing lateritic ore.

14. A process according to claim 5, wherein said oversize fraction is subjected to a secondary crushing step.
